(19) United States
(12) Patent Application Publication
(10) Pub. No.: US 2011/0199762 A1
(43) Pub. Date: Aug. 18, 2011

(54) Light Emitting Diode Based PAPI Design Incorporating Linear Diode Arrays and Cylindrical Optics

(76) Inventor: David Mark Shemwell, Newcastle, WA (US)

(21) Appl. No.: 12/705,025

(22) Filed: Feb. 12, 2010

(51) Int. Cl. F21V 9/00; F21S 4/00; F21V 5/00

(52) U.S. Cl. 362/231; 362/249.02; 362/235

(57) ABSTRACT

This invention presents a method for overcoming limitation in brightness and heating effects for LED based Precision Approach Path Indicators. This method relies on the use of linear arrays of LED's and cylindrical optics

### BACKGROUND OF THE INVENTION

Current PAPI (Precision Approach Path Indicators) rely on conventional light sources and use approximately 2400 watts of electrical power. It is possible to greatly reduce the electrical consumption by switching to high powered LED's (light emitting diodes). However, these devices require a total brightness that is much higher than usually available from LED light sources. One approach is to cluster these LED's into a 2 dimensional array, however it is then very difficult to cool the LED's adequately. In this invention the design uses a linear array of LED's, a linear sector partition optic, and cylindrical lenses to provide the appropriate white and red PAPI sectors.

### SUMMARY OF THE INVENTION

In general terms the current invention uses the technique of cylindrical optics in combination with rows of white and red Light Emitting Diodes (LED's) to provide approach path indications to approaching aircraft of the type known in the industry as PAPI (Precision Approach Path Indicator). The basic function of this invention is as follows: Two sets of LED arrays, one white in color and the other red in color are incident on a beam sharing optic, or alternatively on a sector delineating mask. The beam sharing optic is also linear and directs the red or white light towards the cylindrical lens, while allowing the remaining color to also proceed to the Cylindrical. The beam sharing optic also delineates the red from the white sector. The cylindrical lens then reimages the beam sharing optic so that the white and red sectors are properly formed for the PAPI system to function properly. The optical system must also be protected from the weather and have a means for mounting to standard airport mounting systems. In an alternate embodiment the white and red sector signals can come from separate boxes stacked on top of each other each with a linear array for the white and red sectors respectively, and separate cylindrical optical systems. In this case the beam sharing optic is replaced by a sector delineation mask in each cylindrical optical system. This invention has the advantage over current art in that it can save up to 10 times the electricity (using as little as 200 watt) and maintenance of current PAPI's. An additional advantage is found in the linear nature of this optical system which allows for high levels of brightness of the projected light while providing a superior arrangement for cooling the LED's.

### DESCRIPTION OF THE DRAWINGS

FIG. 1 shows the layout of the cylindrical optical system with its LED arrays, beam combining optic, and cylindrical lens system

FIG. 2 shows one specific embodiment of the LED PAPI arrangement with a cylindrical optical system

### DETAILED DESCRIPTION

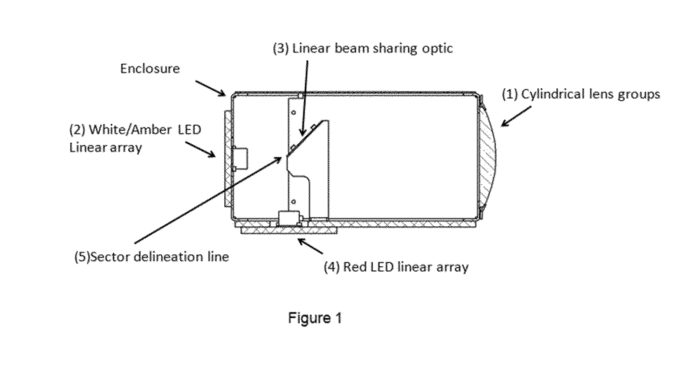

FIG. 1 shows the basic layout of the optical system. An array of LED's of the first color (2) is mounted on the optical head, while an array of LED's of the second color (4) is mounted onto the same optical head. Light from these two arrays of LED is incident on a beam sharing optic (3), or alternatively on a sector delineating masks (5). The beam sharing optic is also linear and directs the red or white light towards the cylindrical lens, while allowing the remaining color to also proceed to the Cylindrical Lens (1). The beam sharing optic also delineates the red from the white sector. The cylindrical lens then reimages the beam sharing optic so that the white and red sectors are properly formed for the PAPI system to function properly. In an alternate embodiment the white and red sector signals can come from separate boxes stacked on top of each other each with a linear array for the white and red sectors respectively, and separate cylindrical optical systems. In this case the beam sharing optic is replaced by a sector delineation mask in each cylindrical optical system.

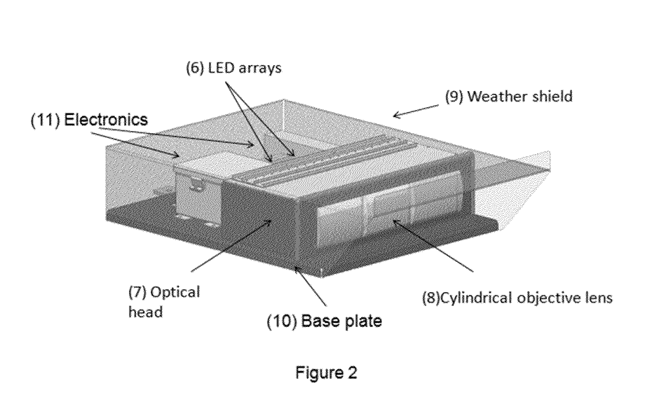

The optical system must also be protected from the weather and have a means for mounting to standard airport mounting systems, as well as placement for electronics and other supporting functions. One practical embodiment of this invention is shown in FIG. 2. As in FIG. 1, FIG. 2 shows the LED arrays (6) (one is hidden from view in this perspective but noted by the arrow), and cylindrical lens system (8). The (7) optical head to which the cylindrical lens and LED arrays are mounted is mounted on a base plate (10) that provides support for the optical head as well as the various electronic packages (11) required to drive the LED arrays and support other functions such as control of brightness and fault detections. In one such embodiment the brightness is controlled by rapidly switching the LED light on and off at a rate that cannot be detected by the human eye. This sort of brightness control is unique to the LED light source and is not available to a PAPI system with contains standard incandescent lights. The entire device is covered by a weather cover (9) for protection from rain and snow.

One advantage of this invention is that it is possible to increase the output power of this design to any level required simply by adding more LED's and optics to the linear array without encounter overheating issues. The length of the array is linear related to the total output of the device adding length will, for any given LED design, increase the possible output of the device in concert with the increase in length. The increase in length has no negative effect on the devices' performance since the cylindrical optical system integrates this linear array at the operating range making it appear to be a single light source

The optical system of this invention also provided flexibility in terms of the apparent color of the projected light. The current high powered LED's that are white in color are often not the proper color. It is possible to use a linear array of “warm white” LED's but this is not as efficient. In this design one option is to use a white, amber, and perhaps some green to achieve the proper color. The cylindrical optical system integrates these separate colors to provide the proper “aviation white” at the operating distance of the PAPI so that the white sector of the PAPI appears as a pure white to the user.

In this invention the linear nature of the optical systems allows for the LED's to be spread out linearly in their array, rather than in a two dimensional array. The linear arrangement allows for enhanced cooling of the LED array since each the waste heat from each LED can propagate laterally from the LED without encountering another LED which would lead to a buildup of waste heat. This build up of waste heat is a limiting factor for LED operation, making the linear array very advantageous.

Although the present invention has been set forth in terms of specific embodiments, it will be apparent to those of skill in the art that numerous modifications and variations can be made without departing from the true spirit and scope thereof as set forth in the following claims.

What is claimed is:

1) A Precision Approach Path Indicator system that is based on LED's arranged in a linear array

2) A Precision Approach Path Indicator system that is based on LED's arranged in a linear array where one array produces the red signal and one array produces the white signal.

3) A Precision Approach Path Indicator system that is based on LED's arranged in a linear arrays whose light is in turn reimaged by a cylindrical lens, or cylindrical lens array.

4) A Precision Approach Path Indicator system that is based on LED's arranged in linear arrays whose light is incident on a sector delineating mask and where the delineating mask is reimage by a cylindrical lens system.

5) A Precision Approach Path Indicator system that is based on LED's arranged in linear arrays whose light is incident on a sector delineating mask and where the delineating mask is reimaged by a cylindrical lens system, and where the delineating mask is also a beam sharing optic so that a single linear cylindrical lens system can provide both the white and red sectors.

6) A Precision Approach Path Indicator system that is based on LED's arranged in a linear array where the white signal is produced by a multicolor array (white and amber for example) is used in combination with a cylindrical optical system to produce the correct shade of white for the PAPI signal while maintaining low electrical consumption.

7) A Precision Approach Path Indicator system based on efficient LED technology that, due to its high electrical efficiency can be powered by a solar electrical system.

8) A Precision Approach Path Indicator using LED technology where the intensity of the light projected is varied by rapid switching of the light from on to off at rates not detectable by the human eye to produce the dimming effect.
